(19) United States
(12) Patent Application Publication
(10) Pub. No.: US 2019/0072021 A1
(43) Pub. Date: Mar. 7, 2019

(54) SOUND GENERATING ASSEMBLY FOR AN EXHAUST SYSTEM

(71) Applicant: Faurecia Emissions Control Technologies, Germany GmbH, Augsburg (DE)

(72) Inventors: Hannes Steinkilberg, Augsburg (DE); Matthias Hildebrand, Obermichelbach (DE)

(21) Appl. No.: 16/121,728

(22) Filed: Sep. 5, 2018

(30) Foreign Application Priority Data
Sep. 7, 2017 (DE) 10 2017 120 610.8

(51) Int. Cl. F01N 13/08; F01N 1/06; H04R 1/02; G10K 11/178; G10K 11/00; F01N 13/18

(52) U.S. Cl. CPC F01N 13/08; F01N 1/065; H04R 1/028; G10K 2210/12822; G10K 11/004; F01N 13/1822; G10K 11/178

(57) ABSTRACT

A sound generating assembly for an exhaust system of an internal combustion engine of a motor vehicle includes a sound generator arranged within a sound generator housing. Furthermore, an outer contour of the sound generator housing has a connecting surface configured to be attached to a motor vehicle structure. The connecting surface is set off from a remaining surface of the outer contour.

### CROSS-REFERENCE TO RELATED APPLICATIONS

This application claims priority to DE 10 2017 120 610.8, filed 7 Sep. 2017.

### FIELD OF INVENTION

The invention relates to a sound generating assembly for an exhaust system of an internal combustion engine of a motor vehicle, which includes a sound generator arranged within a sound generator housing.

### BACKGROUND OF THE INVENTION

Sound generating assemblies of this kind are known from the prior art and can be subdivided essentially into two groups.

A first group of sound generating assemblies serves to dampen the sound carried by an exhaust gas flow. The sound generating assembly is therefore an active sound absorber. To this end, the sound generated by the sound generating assembly is, ideally, adjusted such that it has a substantially equal amplitude with respect to the sound carried by the exhaust gas flow, but a phase shifted by 180°.

The second group relates to sound generating assemblies which are configured to complement the sound carried by an exhaust gas flow. To this end, the sound provided by the sound generating assembly differs, for example, in amplitude and/or frequency from the sound carried by the exhaust gas flow. It is intended here that the sound carried by the exhaust gas flow in combination with the sound provided by the sound generating assembly is perceived as pleasant by a motor vehicle user and/or other persons. It is, for example, possible that a motor vehicle with an internal combustion engine that has only few cylinders (e.g. three) and a comparatively small displacement gives the acoustic impression of having more cylinders (e.g. six) and a larger displacement. In this context, this is often referred to as sound design.

There are, of course, also sound generating assemblies which are designed both to dampen and to complement the sound carried by an exhaust gas flow. These assemblies then belong to both groups mentioned above.

Regardless of the group into which a sound generating assembly is to be classified, it must be directly or indirectly attached to a motor vehicle structure.

In this context, again two basic variants exist. The sound generating assembly may either be connected to the motor vehicle structure via components of the exhaust system associated with it or may be directly attached to it. Combinations are also possible.

Sound generating assemblies that may be directly attached to a motor vehicle structure are known from DE 10 2013 222 548 B3, US 2002/0047074 A1, and U.S. Pat. No. 6,005,957 A, for example.

An attachment of the sound generating assembly to the motor vehicle structure is advantageous in particular in that the components of the associated exhaust system, in particular exhaust pipes and/or exhaust tubes, do not have to be mechanically designed as fastening components. This increases the design freedom in regard to the development thereof and reduces the weight thereof.

It is the object of the invention to indicate a sound generating assembly of the type initially mentioned, which can be simply and reliably attached to a motor vehicle structure, in particular to an exhaust system. In addition, the sound generating assembly is intended to be suitable for being mounted in installation spaces of different sizes and geometries, i.e. to be used in different vehicle variants and models.

### SUMMARY OF THE INVENTION

A sound generating assembly includes a sound generator arranged within a sound generator housing. An outer contour of the sound generator housing has a connecting surface configured to be attached to a motor vehicle structure, in particular to an exhaust system, and the connecting surface is set off from a remaining surface of the outer contour. In this context, the outer contour is essentially understood to mean an envelope of the sound generator housing, with any existing add-on parts, in particular brackets or assembly consoles, not being comprised. The fact that the connecting surface is set off means that an angle, a curvature, an orientation or the like of the outer contour changes at a transition to the connecting surface. The connecting surface is integrally molded into the outer contour of the sound generator housing here. The connecting surface is specially configured to at least contribute to, or assist in, attaching the sound generating assembly to a motor vehicle structure. In this context, the connecting surface may also be referred to as a mounting surface, shoulder surface, or plateau surface. Preferably, the connecting surface satisfies tighter shape and/or positional tolerances than the rest of the outer contour. The coarser tolerancing of the remaining sections of the outer contour, that is, the rest of the outer contour, which usually includes curvatures, rounded portions, and/or similar non-planar sections, results in comparatively low manufacturing costs for the sound generating assembly here. This applies in particular to so-called sound conducting horns or cones, which usually have large-area curvatures. In other words, close shape and/or positional tolerances are observed only where it is necessary in the interest of a positionally and orientationally accurate assembly of the sound generating assembly, namely at the connecting surface. Compared with sound generating assemblies that are connected to a motor vehicle structure via the sound generator housing without a connecting surface being provided, in this way a significantly more precise positioning and orientation of the sound generating assembly at the motor vehicle structure can be ensured.

The connecting surface here is intended in particular for brackets or other connecting elements to be connected to the surface. In particular, the brackets or connecting elements may be welded to the connecting surface.

By joining them onto the connecting surface at different points thereof and/or with different orientations, a sound generating assembly may be provided which can be simply and reliably attached in a variety of installation spaces. Of course, different brackets or connecting elements may also be made use of for this purpose, or their number may be varied. Generally, the sound generating assembly may in this way always be attached to a motor vehicle structure in a simple and reliable manner. At the same time, the connecting surface is preferably arranged at the sound generator housing in such a way that the sound generator is not affected by any mounting or connecting activities. For example, sound generators are often sensitive to temperature. The connecting surface may then be spaced apart from the sound generator such that the latter will not be impaired in terms of its function and/or service life even when welding operations are carried out on the connecting surface. The spacing has to ensure here that neither the conductive heat input nor the heat input due to radiation will cause any damage to the component. Moreover, in this way the sound generator is protected from weld spatter. This makes the sound generating assembly particularly reliable as regards its function.

The sound generator may be a loudspeaker, in particular a 6.5-inch loudspeaker. Loudspeakers have proven themselves as sound generators in sound generating assemblies of the type initially mentioned. Using them allows sound to be generated in a reliable manner at the desired frequencies and amplitudes, so that the desired effect of the sound generating assembly is obtained. With a 6.5-inch loudspeaker, sound carried by an exhaust gas flow can be particularly well dampened and/or complemented here, in particular owing to its comparatively large diameter. This is true, above all, for relatively low frequency ranges.

In a preferred embodiment, the sound generator housing is multi-part, and the connecting surface is formed on a sound generator housing part on the sound outlet side, preferably on a sound conducting horn. The sound conducting horn is frequently also referred to as a sound conducting cone. Multi-part sound generator housings have proven themselves in the prior art. In particular, comparatively low manufacturing costs for the sound generator housing can be combined in this way with a geometry adapted to the sound conduction and/or the desired sound propagation. The arrangement of the connecting surface on a sound generator housing part on the sound outlet side makes the connecting surface particularly easily accessible for assembly work, in particular welding work. Furthermore, the most sensitive components of a sound generator are usually located on its side facing away from the sound generator housing part on the sound outlet side. This is the case in particular with a loudspeaker in which a control electronics and/or an actuator is/are, as a rule, located on the side opposite the sound outlet side. An impairment of the sound generator by assembly work, in particular by temperature development during welding or welding spatter, is thus effectively prevented, as a result of which a high overall reliability and long service life of the sound generating assembly are ensured.

The connecting surface may comprise a joining zone. The joining zone may take up part of the connecting surface or the entire connecting surface here. The joining zone is intended for connecting elements or brackets to be joined therein to the sound generator housing. In case a welding process is used for this, the joining zone may also be referred to as the welding zone.

Further, the connecting surface may be substantially flat. Such a connecting surface is advantageous with regard to simple manufacturability and compliance with tight shape and/or positional tolerances. In other words, a flat connecting surface can be produced particularly simply and precisely. This allows the sound generating assembly to be mounted to a vehicle structure particularly simply and precisely.

Advantageously, the connecting surface is substantially C-shaped. The profile of the connecting surface is therefore curvilinear. In other words, the connecting surface has the shape of a ring section. This does not have to be a circular or elliptical ring. The connecting surface may also have a shape that corresponds to a section of an annular surface with a completely irregular basic shape. Depending on the configuration of the connecting surface, it may also be referred to as U-shaped. The connecting surface thus features a certain course over the sound generator housing. As a result, it may be made use of at different points of the sound generator housing to attach the latter to a motor vehicle structure.

The connecting surface may at least partly surround a sound generator housing axis that is substantially vertical when the sound generating assembly is in the installed position, preferably surrounding the axis by more than 180°. In this configuration, the connecting surface in the installed position thus has a substantially vertical surface normal. Here, the surface normal may be arranged such that in the case of a forming or reshaping production of that sound generator housing part on which the connecting surface is arranged, it corresponds to a direction of demolding or does not constitute an undercut at least with respect to the direction of demolding. This allows the sound generating assembly to be produced in a simple and cost-effective manner. In addition, such a connecting surface is particularly easily accessible for assembly work, in particular welding work. If the connecting surface is arranged on a lower side of the sound generator housing in the installed position, it may be used at least in part for a form-fitting attachment of the sound generating assembly to a motor vehicle structure. For example, a combined form-fitting and substance-to-substance bond may be obtained if in this configuration the sound generating assembly is welded to a motor vehicle structure using brackets. In this way, the sound generating assembly is held particularly reliably.

One to five, preferably one to three and particularly preferably two or three, brackets may be joined to the sound generator housing with the connecting surface, in particular via the joining zone, and bracket ends each facing away from the sound generator housing may be adapted to be connected to the motor vehicle structure. Particularly if a connection exists to a pipe, for example, via the sound outlet opening, only one or two brackets are necessary. This means that the sound generator housing may be attached to the motor vehicle structure via the connecting surface. Additionally, a pipe may be mounted to the sound outlet opening of the sound generator housing. Thus, from a structural perspective, the sound generator housing may be supported by both the brackets and the pipe. The connecting surface, to which the brackets are mounted, is separate from the sound outlet opening. Therefore, supporting the sound generator housing by brackets and a pipe leads to a reliable connection between the sound generator housing and the motor vehicle structure. Preferably, the brackets are welded to the sound generator housing. The number of brackets used may be determined as a function of the size and geometry of the installation space in which the sound generating assembly is to be mounted. In particular, the number of brackets thus depends on the vehicle type or model in which the sound generating assembly is employed. Compared to joining the brackets directly to the sound generator housing contour, rather than to a special connecting surface, this results in a particularly precise, reliable and cost-effective attachment of the sound generating assembly to a motor vehicle structure. The reason for this is that it is usually very complex and therefore cost-intensive to produce the sound generator housing contour as a whole while observing such tight shape and/or positional tolerances that exact positioning is possible.

Preferably, a width of the connecting surface, in particular a width of the joining zone, is larger than a dimension, extending in the same direction as the width, of a contact contour, to be joined to the connecting surface, of a bracket end on the sound generator housing side of each bracket. In this context it is presupposed that a length of the connecting surface, which is C-shaped, for example, is also greater than an associated maximum dimension of a contact contour to be joined to the connecting surface. This results in that the bracket end on the sound generator housing side of a bracket to be connected to, in particular to be welded to, the connecting surface may be arranged at different positions on the connecting surface. In particular, the bracket may be attached at different positions along a transverse extent and along a longitudinal extent of the connecting surface. This allows the positions of the brackets to be made use of for compensating for any possibly existing dimensional and/or shape deviations of the sound generating assembly, more precisely of the sound generator housing or else of the bracket. At the same time, this results in additional degrees of freedom when attaching the sound generating assembly to motor vehicle structures of different types.

The sound generator housing may be multi-part, and at least one of the brackets, preferably all brackets, may be additionally joined to a sound generator housing part on which the connecting surface is not formed. The latter sound generator housing part may be, for example, a housing rear part or a housing intermediate part. In this context, the housing intermediate part may, for example, carry the sound generator, in particular a loudspeaker. The attachment of the at least one bracket to two sound generator housing parts results in a particularly reliable and durable mounting of the sound generating assembly to the motor vehicle structure.

According to one variant, as viewed in a sound radiation direction of the sound generator, the connecting surface is arranged at a lateral distance from the sound generator. This distance prevents the sound generator from being impaired in terms of its function and/or service life by installation work done on the connecting surface. In the event that welded joints are arranged on the connecting surface, in this way it is prevented in particular that the sound generator, which may be a loudspeaker, for example, is exposed to excessive temperatures and/or weld spatter. This results in a reliable and durable sound generating assembly.

### BRIEF DESCRIPTION OF THE DRAWINGS

The invention will be discussed below with reference to an exemplary embodiment that is shown in the accompanying drawings, in which:

FIG. 1 schematically shows a sound generating assembly according to the invention, which is attached to a motor vehicle structure;

FIG. 2 shows the sound generating assembly from FIG. 1 in a partly transparent side view;

FIG. 3 shows the sound generating assembly from FIG. 2 in a view along direction III;

FIG. 4 shows the sound generating assembly from FIG. 3, with a bracket being welded to the assembly as an example;

FIG. 5 shows the sound generating assembly from FIG. 4 in a perspective view, which corresponds to the top view from FIG. 4;

FIG. 6 shows a detail of the sound generating assembly from FIG. 5; and

FIG. 7 shows a detail VII of the sound generating assembly from FIG. 2.

### DETAILED DESCRIPTION

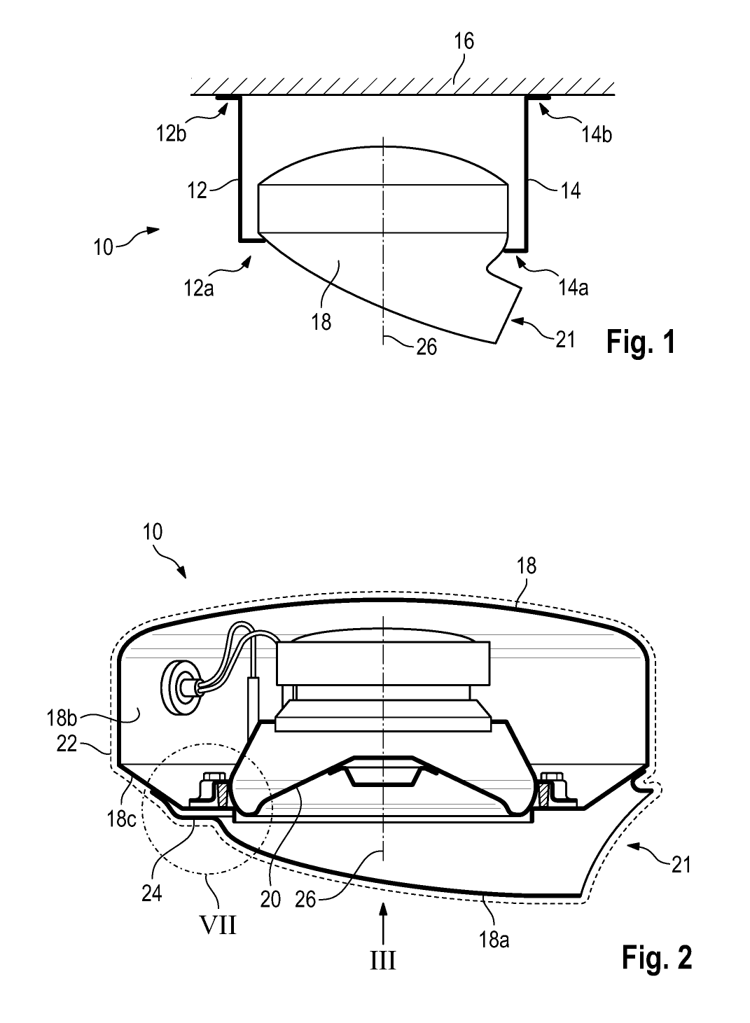

FIG. 1 shows a sound generating assembly 10 for an exhaust system, not illustrated in more detail, of an internal combustion engine of a motor vehicle.

Here, the sound generating assembly 10 is attached to a motor vehicle structure 16 with two brackets 12, 14, illustrated merely schematically, each of which has a bracket end 12a, 14a on a sound generator housing side and a bracket end 12b, 14b on a motor vehicle structure side.

The brackets 12, 14 are welded to the sound generating assembly 10; any other suitable joining method may also be used.

For the connection to the motor vehicle structure 16, any suitable connecting method may be applied.

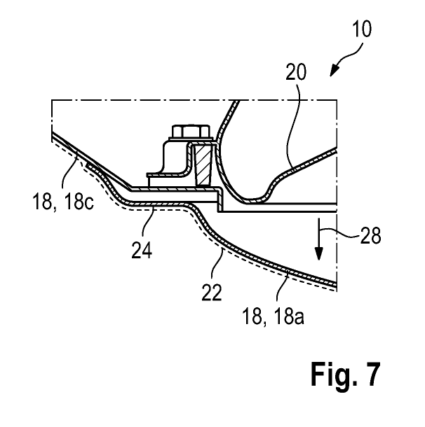

The sound generating assembly 10 comprises a sound generator housing 18 in which a sound generator 20 is arranged which in the illustrated exemplary embodiment is a loudspeaker (see FIGS. 2 and 7). Sound generated by the sound generator 20 is conducted via a sound outlet opening 21 to an environment or into the exhaust system via a linking not shown here.

Furthermore, in the illustrated exemplary embodiment, the sound generator housing 18 has a multi-part configuration. In this connection, the sound generator housing comprises a sound generator housing part 18a on the sound outlet side, which in the present case is configured to be funnel-shaped, in particular as a sound conducting horn or a sound conducting cone. It further includes a sound generator housing rear part 18b and a sound generator housing intermediate part 18c.

In the illustrated embodiment, the sound generator 20 is attached to the sound generator housing intermediate part 18c (see FIGS. 2 and 7).

In order to be able to attach the sound generator housing 18, for example to the motor vehicle structure 16, an outer contour 22, symbolized by a dashed line, of the sound generator housing 18 comprises a connecting surface 24.

The latter is set off from the rest of the outer contour 22.

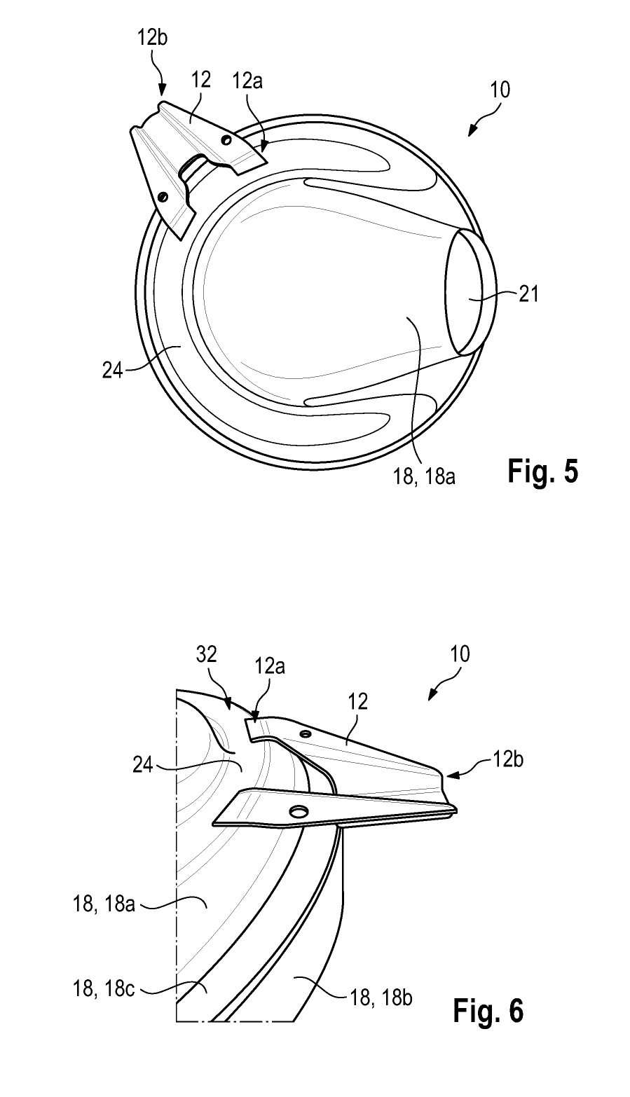

The connecting surface 24 is formed on the sound generator housing part 18a on a sound outlet side (cf. in particular FIGS. 2-7).

Further, the connecting surface 24 is designed to be substantially flat.

Moreover, the connecting surface 24 is C-shaped.

Here, the connecting surface 24 at least partly surrounds a sound generator housing axis 26 that is substantially vertical in an installed position of the sound generating assembly 10.

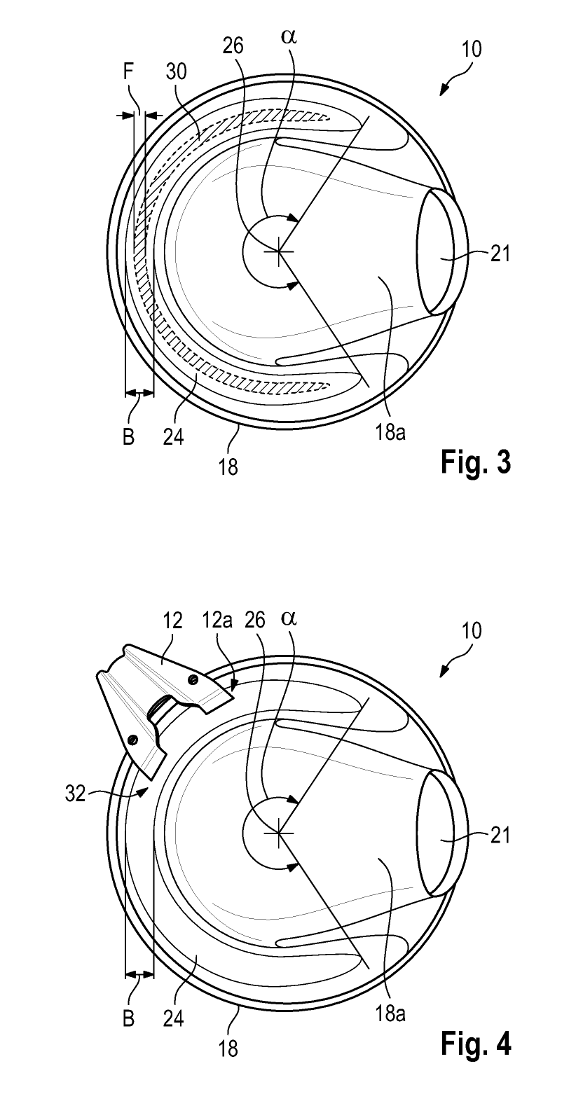

A surround angle α (see FIGS. 3 and 4) is preferably larger than 180° here.

Furthermore, the connecting surface 24 is arranged on the sound generator housing 18 such that, as viewed in a sound radiation direction 28 of the sound generator 20, it is located at a lateral distance from the sound generator 20 (see in particular FIG. 7). In case that the sound generator 20 is a loudspeaker, the lateral distance from a loudspeaker diaphragm is important here, in particular in a radial direction.

The connecting surface 24 comprises a joining zone 30, the shape of which corresponds essentially to that of the connecting surface 24 in the exemplary embodiment shown, with the edge portions of the connecting surface 24, however, being recessed (cf. FIG. 3).

One to five brackets 12, 14 may be joined to the sound generator housing 18 with the connecting surface 24, more precisely via the joining zone 30. For the sake of clarity, FIG. 1 shows only two brackets 12, 14 and FIGS. 4-6 show only one single bracket 12 by way of example.

The number of brackets 12, 14 may be varied depending on the size and geometry of the sound generator housing 18 and/or the installation space in which the sound generating assembly 10 is to be mounted. This makes it possible, among other things, for the sound generating assembly 10 to be employed in different types of vehicles the motor vehicle structures 16 of which exhibit differences in the region of the sound generating assembly 10.

The brackets 12, 14 are each adapted to be connected to, or are connected to, the motor vehicle structure 16 by their respective bracket end 12b, 14b facing away from the sound generator housing 18.

The bracket ends 12a, 14a on the sound generator housing side are each provided with a contact contour 32 that is configured to be joined to the connecting surface 24, more precisely to the joining zone 30.

Each of the contact contours 32 here is dimensioned in an extent corresponding to a width B of the connecting surface 24 and a width F of the joining zone 30 such that the width B of the connecting surface 24 is always larger than the corresponding dimension of the contact contour 32.

This allows the brackets 12, 14 to be connected to the connecting surface 24 or the joining zone 30 at different positions along the directions of the width B and the width F.

In other words, in this way the bracket 12, 14 can be connected to the connecting surface 24, more precisely to the joining zone 30, at slightly different distances from the sound generator housing axis 26 in order to compensate for tolerances.

In addition, one or more of the brackets 12, 14 may be joined to a sound generator housing part on which the connecting surface 24 is not formed. In this context, it is apparent from FIG. 6 in particular that the bracket 12 is connected to the sound generator housing part 18a on the sound outlet side and to the sound generator housing intermediate part 18b.

Although an embodiment of this invention has been disclosed, a worker of ordinary skill in this art would recognize that certain modifications would come within the scope of this disclosure. For that reason, the following claims should be studied to determine the true scope and content of this disclosure.

1. A sound generating assembly for an exhaust system of an internal combustion engine of a motor vehicle comprising:
a sound generator arranged within a sound generator housing;
an outer contour of the sound generator housing having a connecting surface configured to be attached to a motor vehicle structure; and
wherein the connecting surface is set off from a remaining surface of the outer contour, and wherein the connecting surface is separate from a sound outlet opening of the sound generator.

2. The sound generating assembly according to claim 1, wherein the sound generator housing is multi-part and the connecting surface is formed on a sound generator housing part on a sound outlet side.

3. The sound generating assembly according to claim 1, wherein the connecting surface comprises a joining zone.

4. The sound generating assembly according to claim 1, wherein the connecting surface is substantially flat.

5. The sound generating assembly according to claim 1, wherein the connecting surface is substantially C-shaped.

6. The sound generating assembly according to claim 5, wherein the connecting surface at least partly surrounds a sound generator housing axis that is substantially vertical when the sound generating assembly is in an installed position.

7. The sound generating assembly according to claim 3, wherein one to five, preferably one to three and particularly preferably two or three, brackets are joined to the sound generator housing via the connecting surface, in particular via the joining zone, and wherein bracket ends each facing away from the sound generator housing are adapted to be connected to the motor vehicle structure.

8. The sound generating assembly according to claim 7, wherein a width of the joining zone allows a tolerance compensation, more particularly the width is larger than a dimension, extending in the same direction as the width, of a contact contour of a bracket end on the sound generator housing side of each bracket, and wherein the contact contour is to be joined to the connecting surface.

9. The sound generating assembly according to claim 7, wherein the sound generator housing is multi-part, and at least one of the brackets, preferably all brackets, is or are additionally joined to a sound generator housing part on which the connecting surface is not formed.

10. The sound generating assembly according to claim 1, wherein as viewed in a sound radiation direction of the sound generator, the connecting surface is arranged at a lateral distance from temperature-sensitive components of the sound generator, in particular from a bead or diaphragm thereof.

11. The sound generating assembly according to claim 1, wherein the sound generator housing is multi-part, and the mounting of the sound generator and the forming of the connecting surface are effected on different housing parts.

12. The sound generating assembly according to claim 1, wherein the connecting surface is located parallel to and/or in an immediate vicinity of a linking surface of the sound generator on which no welding may be performed due to an associated thermal load.

13. The sound generating assembly according to claim 3, wherein the joining zone has significantly tighter shape and/or positional tolerances than neighboring surfaces of the sound generator housing.

14. The sound generating assembly according to claim 1, wherein the motor vehicle structure comprises an exhaust system.

15. The sound generating assembly according to claim 1, wherein the connecting surface is formed on a sound conducting horn.

16. The sound generating assembly according to claim 6, wherein the connecting surface surrounds the sound generator housing axis by more than 180°.
